(19) United States
(12) Patent Application Publication
(10) Pub. No.: US 2026/0296088 A1
(43) Pub. Date: Oct. 1, 2026

(54) PENCIL LEAD WITH POLYHYDROXYBUTYRIC ACID BINDER AND PENCIL WITH THE LEAD

(71) Applicant: STAEDTLER SE, Nürnberg (DE)

(72) Inventor: Martin JAKOB, Hallstadt (DE)

(21) Appl. No.: 19/101,019

(22) PCT Filed: Aug. 2, 2023
(86) PCT No.: PCT/EP2023/025363

§ 371 Date: Feb. 4, 2025

(30) Foreign Application Priority Data
Aug. 5, 2022 (DE) 10 2022 119 775.1

(51) Int. Cl. B43K 19/02; C09D 13/00

(52) U.S. Cl. CPC B43K 19/02; C09D 13/00

(57) ABSTRACT

A lead for pencils for writing, drawing, decorating and/or cosmetic use that includes a binder, a filler, a colorant and other additives, constituents of the lead being as follows: 5 to 65 wt % of binder including polyhydroxybutyric acid and/or a copolymer with polyhydroxybutyric acid as a first polymer and with a second polymer, 33 to 85 wt % of filler with colorant, 2 to 33 wt % of wax or waxes, 0 to 1 wt % of other additives such as stabilizers, lubricants.

The invention relates to a pencil lead for writing, drawing, painting and/or cosmetic pencils based on biodegradable binders, with the features of claim 1. The invention also relates to a pencil with the pencil lead.

Pencil leads for writing, drawing, painting and/or for cosmetic use with polymers which are produced from crude oil are known.

The publication EP 2 644 407 A1 describes polymer-bonded expanded leads which have biodegradable binders and graphite as a colorant. The strength and the coverage of the mark in leads of this type, in particular in the case of pencil leads for lead pencils, could be optimized to some extent.

Furthermore, the publication DE 19 855325 A1 describes a sheath for coloured leads or leads for lead pencils which is based on cellulose and biodegradable polymers. In this, a plurality of biopolymers are described for sheathing leads, however no indication is given as to how a lead could be constructed with such biopolymers.

A polymer-bonded coloured lead and graphite lead is known from the publication WO 2010/006742 A1. Leads of this type contain a polymer binder, wax, palm oil and fillers. Most polymer leads are based on crude oil products and therefore are directly dependent on the price and availability of the oil. Furthermore, leads which are manufactured on the basis of crude oil-derived polymers consume occurring resources which cannot be regenerated.

Furthermore, polymer-bonded coloured leads and graphite leads are known from the publication U.S. Pat. No. 2,988,784 A1. Leads of this type contain a polymer binder based on cellulose esters, in particular cellulose acetate, wax and filler. Although these leads are constructed from a natural raw material and therefore can degrade completely, the majority thereof consist of the naturally occurring raw material, wood. Because of the great demand for wood, however, it is becoming more and more difficult and expensive to obtain high-quality wood. In addition, manufacturing pencils with cellulose esters has a substantial effect on the dwindling availability of natural woods.

Thus, the objective of the invention is to develop a pencil lead as well as a pencil with the pencil lead for writing, drawing and/or painting, wherein the pencil lead forms an environmentally friendly alternative without at the same time losing the primary properties, for example the sharpening capability, the coloration, the strength, the coverage of the mark and/or the erasability of the pencil lead.

The object of the invention is a pencil lead with the features of claim 1 as well as a pencil with the features of claim 7. Preferred or advantageous embodiments of the invention are defined in the dependent claims and the description which follows.

The invention concerns a pencil lead for writing pencils, drawing pencils, painting pencils and/or cosmetic pencils, consisting of filler, colorant, binder and other additives. The pencil lead may be configured as a coloured pencil lead or as a pencil lead for lead pencils.

The phrase “pencil leads for writing, drawing, painting and/or cosmetics” should in particular be understood to mean pencil leads which are securely inserted in a shaft material, for example wood or extruded mixtures, for example as a polymer blend, wherein these can be sharpened. As an alternative to this, pencil leads may be displaceably mounted in a rigid sheath. Examples in this regard are wood-encased lead pencils and pencil leads for mechanical pencils, for example what are known as retractable pencils or clutch pencils. In this regard, the pencil leads in particular have an external diameter in the region of approximately 0.3 mm to 6 mm.

In accordance with the invention, the pencil lead has the following components with respect to the pencil lead, in particular to the total weight of the pencil lead:

| | |
|---|---|
| 5 to 65% by weight | binder comprising polyhydroxybutyric |
| | acid and/or a copolymer with |
| | polyhydroxybutyric acid as the |
| | first polymer, and a second polymer, |
| 33 to 85% by weight | filler with colorant, |
| 2 to 33% by weight | wax or waxes, |
| 0 to 1% by weight | other additives such as |
| | stabilizers, lubricants. |

In accordance with the invention, the binder comprises polyhydroxybutyric acid. Polyhydroxybutyric acid is abbreviated to PHB and in particular, it is registered in the Chemical Abstracts Service under CAS number: 26063-00-3. The properties of PHB as the polymer can be varied to some extent as a function of the number of monomers in the polymer. Polyhydroxybutyric acid has thermoplastic properties and is biodegradable.

As an alternative or in addition, the binder comprises a copolymer with polyhydroxybutyric acid as the first polymer. The term “copolymer” should be understood to mean a polymer which in particular is composed of exactly two polymers. The polymers of the copolymer are bonded chemically. In the case of the copolymer based on polyhydroxybutyric acid, the first polymer is the polyhydroxybutyric acid. The second polymer is selected in accordance with the stipulations for the properties. Preferably, the second polymer can be manufactured in a biobased manner and/or is biodegradable. Particularly preferably, the second polymer is more flexible than polyhydroxybutyric acid.

Surprisingly, it has been shown that with polyhydroxybutyric acid and/or with a copolymer comprising polyhydroxybutyric acid as the first polymer as a binder, a high quality pencil lead can be manufactured wherein the biodegradability of the polyhydroxybutyric acid constitutes an environmentally friendly alternative.

In one embodiment, the binder has only polyhydroxybutyric acid. In a further embodiment, the binder has only a copolymer with polyhydroxybutyric acid as the first polymer, and a second polymer. In a further embodiment, the binder has a blend of polyhydroxybutyric acid and a copolymer with polyhydroxybutyric acid as the first polymer, and the second polymer.

In particular, the filler is selected from a group comprising hexagonal boron nitride, phyllosilicates, chalk, barite, coloured pigments and/or achromatic pigments or mixtures thereof. This means that a pencil lead can be manufactured which is optimized as regards costs and mechanical properties.

In addition, the filler may comprise graphite and/or carbon black, which act as colorants at the same time. Preferably, graphite and/or carbon black, alone or as a mixture thereof, is selected as the filler and colorant for black pencil leads. It should be noted that black pencil leads are termed pencil leads for lead pencils, or graphite leads.

Colorants serve to colour the pencil lead, so that when writing, a coloured trace mark is visible. In particular, the colorant is selected from a group comprising titanium dioxide, zinc sulphide, coloured pigments, carbon black, graphite and/or mixtures thereof. The colour of the pencil lead can be selected in this manner.

The remaining additives include stabilizers, lubricants.

Stabilizers are added to the pencil lead so that the processes of aging of the polymer are reduced. In this regard, the action of heat, light, ozone and oxygen can lead to aging processes which can be discerned in the deterioration of the properties, for example as variations in colour.

In particular, lubricants are added to the pencil lead, so that in the case of retractable pencils or clutch pencils, the pencil lead does not become stuck in sheath. Furthermore, lubricants bring about facilitated guidance of the pencil over the paper and an improved transfer of the colorant of the pencil lead onto the writing substrate, for example blackboard, paper, concrete, asphalt, skin. In particular, the lubricant contains palm oil.

In one embodiment, the copolymer has a ratio by weight of polyhydroxybutyric acid as the first polymer to the second polymer in the range from 1:10 to 10:1, preferably in the range from 5:10 to 10:5, in particular with respect to the total weight of the binder.

In a further embodiment, the second polymer of the copolymer contains poly(3-hydroxyvaleric acid). In particular, poly(3-hydroxyvaleric acid) is a term for poly(3-hydroxybutyrate-co-3-hydroxyvalerate) and/or is known as PHV (CAS: 83120-66-5). It can be manufactured in a biobased manner and is biodegradable.

In particular, the binder contains only copolymers of polyhydroxybutyric acid as the first polymer with poly(3-hydroxyvaleric acid) as the second polymer with a ratio by weight in the range from 1:10 to 10:1, preferably in the range from 5:10 to 10:5, in particular with respect to the total weight of the binder.

In particular, the binder comprises a blend of polyhydroxybutyric acid, poly(3-hydroxyvaleric acid) and/or polylactic acid. Preferably, the binder consists of the blend. A mixture of polymers is termed a blend.

PLA is a term for polylactic acid, which in particular can be termed a polylactide and/or poly(lactic acid). In particular, PLA is also registered in the Chemical Abstracts Service under the CAS number: 9051-89-2. Depending on the number of monomers in the polymer, the properties of PLA as a polymer may vary to some extent.

PLA is a thermoplastic. PLA has the advantage that it can be manufactured in a biobased manner, so that the use of mineral oil-based raw materials in the pencil can be significantly reduced or completely avoided. PLA is obtained from corn, for example, and is a synthetic polymer belonging to polyesters. Thus, pure PLA is preferably manufactured from renewable raw materials and is not based on fossil raw materials such as mineral oil, for example.

In particular, the binder comprises a blend of polyhydroxybutyric acid, poly(3-hydroxyvaleric acid) and polylactic acid. In particular, the binder comprises a blend of polyhydroxybutyric acid and poly(3-hydroxyvaleric acid). In particular, the binder comprises a blend of poly(3-hydroxyvaleric acid) and polylactic acid. In particular, the binder comprises a blend of polyhydroxybutyric acid and polylactic acid.

In this manner, it is possible to select biodegradable binders with a regard to properties such as mark tracing or mechanical strength.

Other copolymers based on polyhydroxybutyric acid are possible and broaden the choice as regards selecting the various properties. Thus, the mechanical properties, in particular sharpening capability, coloration, strength, coverage of the mark, erasability, etc. and also the manufacturing costs, can be adjusted.

In a preferred embodiment, the pencil lead has a binder content which is preferably in the range from 8 to 50% by weight, preferably in the range from 15 to 27% by weight with respect to the total mass of the pencil lead. This has the advantage that for the binder fraction, the manufacturing costs, with the provision of mechanical properties for the pencil lead at the same time, can be optimized.

In a further embodiment, the pencil lead has at least one wax or a mixture of waxes as a wax mixture. The at least one wax is selected from a group comprising fatty acids, stearates, montan wax, amide wax, carnauba waxes, beeswax, paraffin, polyolefin waxes, polyethylene wax, polyethylene vinyl acetate waxes and mixtures thereof. In addition, the wax comprises other additives. A plurality of different waxes may be used as a wax mixture.

Preferably, the wax has a mixture of polyethylene wax and/or polyethylene vinyl acetate wax.

Preferably, the at least one wax is selected from the group comprising calcium stearate and/or ethylene bis stearamide (EBS). In particular, ethylene bis(stearamide) is a term for distearyl ethylene diamide and/or is known as EBS (in particular CAS: 110-30-5). Calcium stearate (CAS: 1592-23-0) is also listed in the European list of food additives as E470a. In addition, in particular, the wax comprises biomers from the company Deurex.

In a further embodiment, the pencil lead has a colorant content in the range from 0 to 10% by weight with respect to the pencil lead.

In a further embodiment, the pencil lead has the following components with respect to the pencil lead, in particular with respect to the total weight of the pencil lead:

| | |
|---|---|
| 8 to 50% by weight | binder comprising |
| | polyhydroxybutyric |
| | acid and/or a |
| | copolymer with |
| | polyhydroxybutyric |
| | acid as the first |
| | polymer, and |
| | a second polymer, |
| 40 to 80% by weight | filler with colorant, |
| 5 to 2 % by weight | wax or waxes, |
| 0 to 1% by weight | other additives |
| | such as |
| | stabilizers, |
| | lubricants. |

In particular, when using the pencil lead in a pencil with a shaft, a bonding agent is employed. The bonding agent has the advantage that the pencil lead is disposed in the shaft in a displacement-resistant manner. In this manner, the pencil lead is not displaced into the shaft when placed under slight pressure during writing.

The invention furthermore pertains to a pencil with the pencil lead, as has been described above. In particular, the pencil is configured as a writing pencil, drawing pencil, painting pencil and/or cosmetic pencil. The pencil has the pencil lead and a shaft, wherein preferably, the shaft surrounds the pencil lead concentrically and/or coaxially. Preferably, the pencil lead and the shaft are disposed relative to one another in a displacement-resistant and/or non-displaceable manner. In particular, the pencil lead is permanently non-detachably fixed in the shaft and/or cannot be detached in a non-destructive manner. As an alternative to this, the pencil lead is displaceably mounted in the pencil. By way of example, the pencil is configured as a retractable pencil or clutch pencil.

Further features, advantages and effects of the invention will become apparent from the following description of preferred exemplary embodiments of the invention:

The pencil lead in accordance with the invention is preferably manufactured as a rod of a pencil lead in the extrusion process or co-extrusion process at approximately 150 to 200° C., following mixing and granulation of the components of the pencil lead.

The shape of the cross sectional surface of the pencil lead is set in the extrusion head. When pencil leads are manufactured for clutch pencils, in addition, the pencil lead rod is cut to a specific length. In the case of pencil leads for shafted pencils, sheathing of the pencil lead with a shaft material is carried out as one of the further process steps.

Exemplary compositions for pencil leads are provided below.

Example 1: Pencil lead with the following components:

| | |
|---|---|
| 17.5% by weight | polyhydroxybutyric acid |
| | as the binder, |
| 67.5% by weight | talc and/or kaolin as the filler, |
| 7% by weight | carbon black as the colorant, |
| 3% by weight | polyethylene wax |
| | as the wax, |
| 5% by weight | polyethylene vinyl acetate |
| | wax as the wax. |

The advantage is the high proportion of filler in combination with the biodegradable binder, whereupon a substantially biodegradable pencil lead can be manufactured.

Example 2: Pencil lead for lead pencils as the pencil lead with the following components:

| | |
|---|---|
| 60% by weight | copolymer of |
| | polyhydroxybutyric acid and |
| | poly (3-hydroxyvaleric acid) |
| | in a ratio by |
| | weight of 2:1, in |
| | particular with respect |
| | to the total weight of the |
| | binder, preferably |
| | corresponding to |
| | 40% by weight |
| | polyhydroxybutyric acid |
| | and 20% by weight |
| | poly (3-hydroxyvaleric acid), |
| | as the binder, |
| 34% by weight | graphite and carbon black, |
| | in particular in a ratio |
| | by weight of 1:2, |
| | as the filler with colorant, |
| 2% by weight | polyethylene wax |
| | as the wax, |
| 4% by weight | polyethylene vinyl acetate |
| | wax as the wax. |

The copolymer reduces the proportion of crystalline regions and facilitates mark tracing of the pencil lead, and therefore facilitates writing.

Example 3: Pencil lead with the following components:

| | |
|---|---|
| 26% by weight | polyhydroxybutyric acid as the binder, |
| 55% by weight | phyllosilicates as the filler, |
| 10% by weight | red pigment as the colorant, |
| 5% by weight | polyethylene wax as the wax, |
| 3% by weight | polyethylene vinyl acetate wax as the wax, |
| 1% by weight | palm oil as the lubricant. |

Example 4: Pencil lead with the following components:

| | |
|---|---|
| 7% by weight | poly (3-hydroxyvaleric acid) |
| | as the binder, |
| 81% by weight | graphite as the filler, |
| 2% by weight | carbon black as the colorant, |
| 6% by weight | ethylene bis stearamide |
| | as the wax, |
| 4% by weight | calcium stearate |
| | as the wax. |

Example 5: Pencil lead with the following components:

| | |
|---|---|
| 40% by weight | copolymer of |
| | polyhydroxybutyric acid and |
| | poly (3-hydroxyvaleric acid) |
| | as the binder, in particular |
| | in a ratio of 1:4, in |
| | particular with respect |
| | to the total weight |
| | of the binder, |
| | preferably corresponding to |
| | 8% by weight |
| | polyhydroxybutyric acid and |
| | 32% by weight poly |
| | (3-hydroxyvaleric acid), |
| 46% by weight | barite as the filler, |
| 10% by weight | yellow pigment |
| | as the colorant, |
| 2% by weight | polyethylene wax |
| | as the wax, |
| 2% by weight | calcium stearate |
| | as the wax. |

Example 6: Pencil lead with the following components:

| | |
|---|---|
| 16% by weight | mixture or blend of polyhydroxybutyric acid |
| | and polylactic acid as the binder, in |
| | particular in a ratio of 3:1, preferably |
| | corresponding to 12% by weight |
| | polyhydroxybutyric acid |
| | and 4 % by weight |
| | polylactic acid, |
| 74% by weight | hexagonal boron nitride as the filler, |
| 5% by weight | carbon black and titanium dioxide pigment |
| | as the colorants, |
| 4% by weight | ethylene bis stearamide as the wax, |
| 6% by weight | polyethylene vinyl acetate wax as the wax. |

Example 7: Pencil lead with the following components:

| | |
|---|---|
| 26 % by weight | mixture or blend of polyhydroxybutyric acid |
| | and polylactic acid as the binder, in |
| | particular in a ratio of 27:10, preferably |
| | corresponding to 19% by weight |
| | polyhydroxybutyric acid and 7% by weight |
| | polylactic acid, |
| 55% by weight | phyllosilicates as the filler, |
| 10% by weight | green pigment as the colorant, |
| 5% by weight | polyethylene wax as the wax, |
| 3% by weight | polyethylene vinyl acetate wax as the wax, |
| 1% by weight | palm oil as the lubricant. |

Pencil leads which have a biodegradable binder can be manufactured with these examples.

1-10. (canceled)

11. A pencil lead for writing pencils, drawing pencils, painting pencils and/or cosmetic pencils, comprising: a binder; a filler; a colorant; and other additives, wherein the pencil lead includes the following components:

| | |
|---|---|
| 5 to 65% by weight | binder comprising |
| | polyhydroxybutyric acid and/or a |
| | copolymer with |
| | polyhydroxybutyric acid as a |
| | first polymer, and a second |
| | polymer; |
| 33 to 85% by weight | filler with colorant; |
| 2 to 33% by weight | wax; and |
| 0 to 1% by weight | other additives. |

12. The pencil lead according to claim 11, wherein the other additives are stabilizers and/or lubricants.

13. The pencil lead according to claim 11, wherein the binder is biodegradable.

14. The pencil lead according to claim 11, wherein the copolymer has a ratio by weight of polyhydroxybutyric acid as the first polymer to the second polymer in a range from 1:10 to 10:1.

15. The pencil lead according to claim 14, wherein the copolymer has a ratio by weight of polyhydroxybutyric acid as the first polymer to the second polymer in a range from 5:10 to 10:5.

16. The pencil lead according to claim 11, wherein the second polymer of the copolymer comprises poly(3-hydroxyvaleric acid).

17. The pencil lead according to claim 16, wherein the copolymer of the binder with polyhydroxybutyric acid and poly(3-hydroxyvaleric acid) as the second polymer comprises a ratio by weight in a range from 1:10 to 10:1.

18. The pencil lead according to claim 17, wherein the copolymer of the binder with polyhydroxybutyric acid and poly(3-hydroxyvaleric acid) as the second polymer comprises a ratio by weight in a range from 5:10 to 10:5.

19. The pencil lead according to claim 11, wherein the binder comprises a blend of polyhydroxybutyric acid, poly(3-hydroxyvaleric acid) and/or polylactic acid.

20. The pencil lead according to claim 11, wherein the pencil lead has a binder content in a range from 8 to 50% by weight with respect to the pencil lead.

21. The pencil lead according to claim 20, wherein the binder content is in a range from 15 to 27% by weight with respect to the pencil lead.

22. The pencil lead according to claim 11, wherein the pencil lead has a wax content in a range from 2 to 33% by weight with respect to the pencil lead.

23. The pencil lead according to claim 22, wherein the wax content is in a range from 5 to 28% by weight with respect to the pencil lead.

24. The pencil lead according to claim 11, wherein the pencil lead has a colorant content in a range from 0 to 10% by weight with respect to the pencil lead.

25. A pencil comprising a pencil lead according to claim 11.
